(19) United States
(12) Patent Application Publication
(10) Pub. No.: US 2025/0209732 A1
(43) Pub. Date: Jun. 26, 2025

(54) THREE-DIMENTIONAL SCENE RECONSTRUCTION METHOD AND APPARATUS, DEVICE, AND STORAGE MEDIUM

(71) Applicant: Beijing Zitiao Network Technology Co., Ltd., Beijing (CN)

(72) Inventor: Shuxue PENG, Beijing (CN)

(21) Appl. No.: 18/986,484

(22) Filed: Dec. 18, 2024

(30) Foreign Application Priority Data
Dec. 26, 2023 (CN) 202311808802.0

(51) Int. Cl. G06T 15/20; G06T 7/55; G06T 7/90; G06V 10/74; G06V 10/762; G06V 10/77; G06V 20/64; G06V 20/70

(52) U.S. Cl. CPC G06T 15/205; G06T 7/55; G06T 7/90; G06T 2207/10024; G06T 2207/10028; G06T 2210/12; G06V 10/74; G06V 10/762; G06V 10/77; G06V 20/647; G06V 20/70

(57) ABSTRACT

The embodiments of the present application provide a three-dimensional scene reconstruction method and apparatus, a device and a storage medium. The method comprises: acquiring a color image and a depth image of a three-dimensional scene at the same time; determining, based on the depth image, prior depths of object pixel points obtained after depth clustering in a detection frame of each object in the color image; performing depth diffusion on the pixel points in the detection frame based on color information of each pixel point in the detection frame and the prior depths of the object pixel points to obtain an actual depth of each pixel point in the detection frame, so as to generate a minimum bounding box of the object.

### CROSS REFERENCE TO RELATED APPLICATIONS

The present application is based on and claims priority to Chinese Patent Application No. 202311808802.0 filed on Dec. 26, 2023, the disclosure of which is incorporated by reference herein in its entirety.

### TECHNICAL FIELD

Embodiments of the present application relate to the technical field of data processing, in particular to a three-dimensional scene reconstruction method and apparatus, a device and a storage medium.

### BACKGROUND

With the rapid development of Extended Reality (XR) technologies, three-dimensional scene reconstruction technologies can provide users with more and more virtual interactive scenes to enhance their immersive interactive experience in three-dimensional scenes.

In general, it is possible to take scene images from multiple perspectives on a three-dimensional scene so as to form a corresponding scene image sequence. Then, the Structure From Motion (SFM) is used to analyze the scene image sequence so as to determine sparse three-dimensional structures of the objects in the three-dimensional scene. Furthermore, the sparse three-dimensional structures of the objects are processed by the Multi-View Stereo (MVS) reconstruction, and densified three-dimensional structure grids of the objects can be obtained, so as to implement three-dimensional reconstruction of the objects in the three-dimensional scene.

However, the above three-dimensional reconstruction mode consumes a lot of computational power for the scene image sequence, and cannot ensure accuracy of three-dimensional scene reconstruction.

### SUMMARY

Embodiments of the present application provide a three-dimensional scene reconstruction method and apparatus, device, and storage medium, which can implement efficient and accurate reconstruction of the objects in the three-dimensional scene, reduce the computational overhead in reconstruction of the objects in the three-dimensional scene, and improve the reconstruction reliability of the objects in the three-dimensional scene.

In a first aspect, an embodiment of the present application provides a three-dimensional scene reconstruction method, which comprises:
acquiring a color image and a depth image of a three-dimensional scene at the same time;
determining, based on the depth image, prior depths of object pixel points obtained after depth clustering in a detection frame of each object in the color image;
performing depth diffusion on the pixel points in the detection frame based on color information of each pixel point in the detection frame and the prior depths of the object pixel points to obtain an actual depth of each pixel point in the detection frame, so as to generate a minimum bounding box of the object.

In a second aspect, an embodiment of the present application provides a three-dimensional scene reconstruction apparatus, which comprises:
an image acquisition module for acquiring a color image and a depth image of a three-dimensional scene at the same time;
a prior depth determination module for determining, based on the depth image, prior depths of object pixel points obtained after depth clustering in a detection frame of each object in the color image;
a depth diffusion module for performing depth diffusion on the pixel points in the detection frame based on color information of each pixel point in the detection frame and the prior depth of the object pixel point to obtain an actual depth of each pixel point in the detection frame, so as to generate a minimum bounding box of the object.

In a third aspect, an embodiment of the present application provides an electronic device, which comprises:
a processor and a memory, wherein the memory is used for storing a computer program, and the processor is used for calling and operating the computer program stored in the memory to execute the three-dimensional scene reconstruction method provided in the first aspect of the present application.

In a fourth aspect, an embodiment of the present application provides a computer-readable storage medium for storing a computer program that causes a computer to execute the three-dimensional scene reconstruction method as provided in the first aspect of the present application.

In a fifth aspect, an embodiment of the present application provides a computer program product, including computer programs/instructions, which cause a computer to execute the three-dimensional scene reconstruction method as provided in the first aspect of the present application.

According to the technical solution of the present application, firstly, a color image and a depth image of a three-dimensional scene at the same time after calibration and alignment are acquired, and prior depths of object pixel points obtained after depth clustering in a detection frame of each object in the color image are determined based on matching of pixel points between the color image and the depth image. Then, depth diffusion is performed on the pixel points in the detection frame of the object based on color information of each pixel point in the detection frame of each object and the prior depths of the object pixel points to generate a minimum bounding box of the object.

### BRIEF DESCRIPTION OF THE DRAWINGS

In order to explain the technical solution in the embodiments of the present application more clearly, the drawings needed in the description of the embodiments will be briefly introduced below. Obviously, the drawings in the following description are only some embodiments of the present application. For those skilled in the art, other drawings can be obtained according to these drawings without inventive effort.

FIG. 1 is a flow diagram of a three-dimensional scene reconstruction method provided by an embodiment of the present application;

FIG. 2 is a flow diagram of another three-dimensional scene reconstruction method provided by an embodiment of the present application;

FIG. 3 is an exemplary schematic diagram of a process of matching pixel points between a depth image and a color image provided by an embodiment of the present application;

FIG. 4 is a method flow diagram of a process of determining object pixel points in a detection frame of each object and prior depths of the object pixel points provided by an embodiment of the present application;

FIG. 5 is a principle block diagram of a three-dimensional scene reconstruction apparatus provided by an embodiment of the present application;

FIG. 6 is a schematic block diagram of an electronic device provided by an embodiment of the present application.

### DETAILED DESCRIPTION

The technical solution in the embodiments of the present application will be clearly and completely described below with reference to the drawings in the embodiments of the present application. Obviously, the described embodiments are only a portion of the embodiments of the present application, but not all the embodiments. Based on the embodiments in the present application, all the other embodiments obtained by those skilled in the art without inventive effort belong to the protection scope of the present application.

It is to be noted that the terms “first” and “second” in the Description and Claims as well as the above drawings of the present application are used to distinguish similar objects, and are not necessarily used to describe a specific order or sequence. It should be understood that the data so used can be interchanged under appropriate circumstances, so that the embodiments of the present application described herein can be implemented in other orders than those illustrated or described herein. Furthermore, the terms “including” and “having” and any variations thereof are intended to cover non-exclusive inclusion, for example, a process, method, system, product or server that contains a series of steps or units is not necessarily limited to those steps or units explicitly listed, but may include other steps or units not explicitly listed or inherent to the process, method, product or device.

In the embodiments of the present application, the words “illustratively” or “for example” are used as examples, illustrations or explanations, and any embodiment or solution described as “illustratively” or “for example” in the embodiments of the present application should not be interpreted as being more preferred or advantageous than other embodiments or solutions. To be exact, the use of words such as “illustratively” or “for example” aims to present related concepts in a concrete way.

In order to enhance the diversified interaction between users and the objects in a three-dimensional scene, it is usually possible to reconstruct a corresponding virtual scene for the three-dimensional scene and reconstruct, in the virtual scene, corresponding virtual models for each of the objects in the three-dimensional scene, so as to support users to perform various interactive operations with the virtual models of each of the objects in the virtual scene, thus improving the immersive interactive experience between users and each of the objects in the three-dimensional scene.

Before introducing the specific technical solution of the present application, the virtual scene after three-dimensional scene reconstruction and the specific application scene of the virtual model after reconstruction of each of the objects in the three-dimensional scene in the present application are firstly explained, respectively.

The present application can allow any virtual scene after three-dimensional scene reconstruction and the virtual models after reconstruction of each of the objects in the virtual scene to be presented in mobile phones, tablet computers, personal computers, servers and smart wearable devices, so that users can view the virtual models after reconstruction of each of the objects in the virtual model after three-dimensional scene reconstruction. When the virtual scene after three-dimensional scene reconstruction and the virtual models after reconstruction of each of the objects in the virtual scene are presented on an XR device, users can enter the virtual scene after three-dimensional scene reconstruction by wearing the XR device, so as to perform various interactive operations with the virtual models after reconstruction of each of the objects in the virtual scene, thus implementing diversified interaction between users and each of the objects in the three-dimensional scene.

The XR refers to a human-computer interactive virtual environment made by combining reality and virtuality through computers. The XR is also a general term for various technologies such as Virtual Reality (VR), Augmented Reality (AR) and Mixed Reality (MR). By merging the three visual interaction technologies, it brings “immersion” of seamless transition between the virtual world and the real world to experiencers. The XR device is usually worn on a user' head, so the XR device is also referred to as a head mount device.

VR: it is a technology of creating and experiencing a virtual world, which generates a virtual environment by computation. It is a kind of multi-source information (the virtual reality mentioned herein includes at least visual perception, in addition, it can also include auditory perception, tactile perception, motion perception, and even taste perception, smell perception, etc.), and implements a blended and interactive simulation of three-dimensional dynamic scenes and entity behaviors of the virtual environment, so that users can immerse themselves in a simulated virtual reality environment to implement applications in various virtual environments such as maps, games, videos, education, medical care, simulation, collaborative training, sales, assistance in manufacturing, maintenance and repair.

A VR device refers to a terminal that implements the virtual reality effect, and it can usually be provided in the form of glasses, Head Mount Displays (HMDs) and contact lenses for implementing visual perception and perception in other forms. Certainly, the forms in which the virtual reality device is implemented are not limited to these, and it can be further miniaturized or enlarged as needed.

AR: an AR scene refers to a simulated scenery in which at least one virtual object is superimposed on a physical scenery or its representation. For example, an electronic system can have an opaque display and at least one imaging sensor for capturing images or videos of the physical scenery, and these images or videos are representations of the physical scenery. The system combines images or videos with a virtual object and displays the combination on an opaque display. Individuals use the system to indirectly view the physical scenery via the images or videos of the physical scenery, and observe the virtual object superimposed on the physical scenery. When the system uses one or more image sensors to capture images of a physical scenery and uses those images to present an AR scenery on an opaque display, the displayed images are referred to as video transmission. Alternatively, the electronic system for displaying the AR scenery can have a transparent or translucent display through which individuals can directly view the physical scenery. The system can display a virtual object on a transparent or translucent display, so that individuals can use the system to observe the virtual object superimposed on the physical scenery. As another example, the system can include a projection system that projects a virtual object into a physical scenery. The virtual object can be projected, for example, on a physical surface or as a hologram, so that individuals use the system to observe the virtual object superimposed on the physical scenery, specifically, in the process of capturing images by a camera, a technology of computing, in real time, the camera attitude information parameters of the camera in the real world (or the three-dimensional world or the real world) and adding virtual elements to the images captured by the camera based on the camera attitude information parameters. The virtual elements include, but are not limited to, images, videos and three-dimensional models. The goal of AR technologies is to superimpose the virtual world on the real world for interaction on a screen.

MR: by presenting virtual scene information in the real scene, an interactive feedback information loop is set up among the real world, the virtual world and the users to enhance the realism of the user experience. For example, a computer-created sensory input (for example, a virtual object) is integrated with a sensory input from a physical scenery or its representation in a simulated scenery, and in some MR sceneries, the computer-created sensory input can adapt to changes of the sensory input from the physical scenery. In addition, some electronic systems for presenting MR sceneries can monitor orientation and/or position information relative to the physical scenery to enable virtual objects to interact with real objects, i.e., physical elements from the physical scenery or their representations. For example, the system can monitor movement so that a virtual plant seems stationary relative to a physical building.

Optionally, the XR device described in the embodiments of the present application, also referred to as a virtual reality device, can include but is not limited to the following types:
1) Mobile virtual reality device, which supports various setting (such as a head mount display provided with special card slots) of a mobile terminal (such as a smart phone), wherein through a connection with the mobile terminal in wired or wireless way, the mobile terminal performs relevant computations of virtual reality functions and outputs data to the mobile virtual reality device, such as watching virtual reality videos through an APP of the mobile terminal.
2) All-in-one virtual reality device, which is provided with a processor for performing relevant computations of virtual functions, so that it has independent virtual reality input and output functions, without being connected with a PC or a mobile terminal, and it has high freedom of use.
3) Personal computer virtual reality (PCVR) device, which uses a PC terminal to perform relevant computations of virtual reality functions and data output, wherein an external computer-side virtual reality device uses data output from the PC to implement virtual reality effects.

After introduction of specific application scenes that can be presented by the virtual scene after three-dimensional scene reconstruction in the present application, a three-dimensional scene reconstruction method provided by an embodiment of the present application will be explained in detail in combination with the drawings below.

At present, the traditional three-dimensional scene reconstruction modes have too much computational power consumption, and cannot ensure the accuracy of three-dimensional scene reconstruction.

In order to solve the above problem, the inventive concept of the present application is as follows. Firstly, a color image and a depth image of a three-dimensional scene at the same time after calibration and alignment are acquired, and prior depths of object pixel points obtained after depth clustering in a detection frame of each object in the color image are determined based on matching of pixel points between the color image and the depth image. Then, depth diffusion is performed on each of the pixel points in the detection frame of each object based on color information of each pixel point in the detection frame of the object and the prior depths of the object pixel points to generate a minimum bounding box of the object. That is, it is possible to approximately replace each of the complex objects with the minimum bounding box with a simple geometric structure, which can implement efficient and accurate reconstruction of each of the objects in the three-dimensional scene, and perform depth diffusion on each of the pixel points in the detection frame of each object, which can greatly reduce the computational overhead in reconstruction of each of the objects in the three-dimensional scene and can improve the reconstruction reliability of each of the objects in the three-dimensional scene.

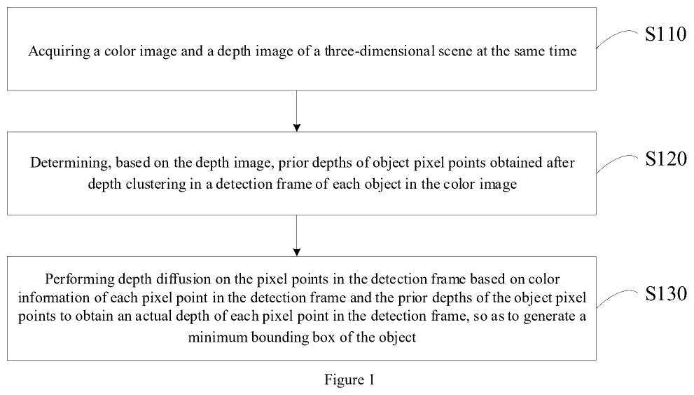

FIG. 1 is a flow diagram of a three-dimensional scene reconstruction method provided by an embodiment of the present application. The method can be executed by a three-dimensional scene reconstruction apparatus provided by the present application, wherein the three-dimensional scene reconstruction apparatus can be implemented by any software and/or hardware. Illustratively, the three-dimensional scene reconstruction apparatus can be configured in any electronic device such as XR devices, servers, mobile phones, tablet computers, personal computers, or smart wearable devices. The present application does not impose any limitation on specific types of the electronic device.

Specifically, as shown in FIG. 1, the method can include the following step:
S110, acquiring a color image and a depth image of a three-dimensional scene at the same time.

The three-dimensional scene in the present application can be any real scene where users are located, such as a certain game scene or indoor scene. In general, a variety of real objects, such as tables, chairs, sofas, coffee tables, cabinets, refrigerators, and televisions, can be provided in the three-dimensional scene to support diversified interaction of users with each of the objects in the three-dimensional scene. Then, in three-dimensional scene reconstruction, it is necessary to reconstruct each of the objects in the three-dimensional scene. The reconstruction of each of the objects in the three-dimensional scene needs to use point cloud information of each of the objects at the three-dimensional scene.

Therefore, in order to ensure the accurate reconstruction of each of the objects in a three-dimensional scene, for an electronic device (such as an XR device) for three-dimensional scene reconstruction, the present application can provide an ordinary camera and a depth camera on the electronic device, and perform calibration and alignment on the ordinary camera and the depth camera in advance to acquire a coordinate transformation relationship of the ordinary camera and the depth camera after calibration and alignment, so as to subsequently accurately analyze the position matching of the same object in two images shot by the ordinary camera and the depth camera.

Then, in order to accurately acquire point cloud data of each object in the three-dimensional scene, the present application can use an ordinary camera and a depth camera to scan the real environmental information in the three-dimensional scene based on a certain shooting frequency (for example, every 0.5 ms), so as to obtain a color image shot by the ordinary camera for the three-dimensional scene at a certain time and a depth image shot by the depth camera for the three-dimensional scene at a certain time. Therefore, the present application can acquire the color image and the depth image of the three-dimensional scene at the same time, so as to subsequently analyze spatial position information of the same object in the three-dimensional scene and obtain the point cloud data corresponding to each of the objects.

Each pixel point in the color image can carry corresponding color information, and each pixel point in the depth image can carry corresponding depth information.

It can be understood that, after the ordinary camera and the depth camera are subject to calibration and alignment, the color image and depth image shot by them are also subject to calibration and alignment. It is possible to determine the coordinate transformation relationship between the color image and the depth image, so as to accurately analyze the matching between each of the pixel points in the color image and the depth image.

S120, determining, based on the depth image, prior depths of object pixel points obtained after depth clustering in a detection frame of each object in the color image.

In order to reduce the computational overhead in reconstruction of each of the objects in the three-dimensional scene, after acquiring the color image of the three-dimensional scene, the present application will first use a pre-configured target detection algorithm to perform corresponding target detection processing on the color image, and select each of the objects from the color image, so as to obtain the detection frame of each object in the color image.

Illustratively, the detection frame of each object can be a rectangular frame that can completely enclose the object, so as to describe the position information of the object in the color image.

Since each object in the color image usually appears in the detection frame of the object, instead of other areas of the color image, in reconstruction of each object, the present application can perform depth analysis on pixel points in the detection frame of each object in the color image without analyzing the depth information of each of the pixel points in the whole color image, which greatly reduces the computational overhead in reconstruction of each of the objects in the three-dimensional scene.

For the detection frame of each object in the color image, the present application can first use the coordinate transformation relationship of the ordinary camera and the depth camera after calibration and alignment to match each of the pixel points in the depth image and the detection frame of the object, so as to determine a portion of pixel points in the detection frame of the object that match each of the pixel points in the depth image. Then, the depth information of the portion of pixel points in the detection frame of the object that match each of the pixel points in the depth image can be determined based on the depth information of each of the pixel points in the depth image.

It can be understood that the pixel points in the detection frame of each object in the color image can be divided into two types, i.e., object pixel points inside the object and non-object pixel points outside the object. The non-object pixel points can be the outer points for representing background information of the three-dimensional scene in the detection frame of the object.

However, a depth difference of each of the object pixel points inside the same object in the color image is small, while a difference of the depths facing users is large between pixel points of a certain object and other object or background in the color image. Therefore, in order to ensure the efficient reconstruction of each of the objects in the three-dimensional scene, for the detection frame of each object, the present application can perform cluster processing on a portion of pixel points in the detection frame that matches each of the pixel points in the depth image by analyzing the depth information of the portion of pixel points in the detection frame, so as to divide the portion of pixel points in the detection frame of the object into object pixel points and non-object pixel points. Moreover, for each object pixel point in the detection frame of the object, the present application can take the depth information of the pixel point matched with the object pixel point in the depth image as the prior depth of the object pixel point.

In the same way as above, the prior depths of each of the object pixel points obtained after depth clustering in the detection frame of each object in the color image can be determined.

S130, performing depth diffusion on the pixel points in the detection frame based on color information of each pixel point in the detection frame and the prior depths of the object pixel points to obtain an actual depth of each pixel point in the detection frame, so as to generate a minimum bounding box of the object.

Since the pixel resolution of the color image will be usually higher than that of the depth image, the number of pixel points in the color image will be larger than that in the depth image. Thus, it can be learned that the object pixel points whose prior depths have been determined in the detection frame of each object in the color image belong to a portion of pixel points in the detection frame of the object, and the object pixel points in the detection frame of the object are uniformly distributed.

Then, in order to implement the accurate reconstruction of each of the objects in the three-dimensional scene, the present application needs to further comprehensively analyze the depth information of each of the pixel points in the detection frame of the object based on the prior depths of the portion of object pixel points in the detection frame of each object.

Considering that the depth difference of two pixel points belonging to the same object in the color image is not large, and if a color difference of two pixel points in the detection frame of the object is not large, it means that the two pixel points are pixel points on the same object, then the depth difference of the two pixel points is not large either. Moreover, any two adjacent pixel points in the detection frame of a certain object in the color image may usually represent the same object approximately, so that the depth difference between any two adjacent pixel points is as small as possible.

Therefore, for the detection frame of each object in the color image, the present application can first determine color information of each pixel point in the detection frame and analyze the color change situation of each of the pixel points in the detection frame. Furthermore, with reference to the prior depths of each of the object pixel points which have been determined in the detection frame of the object, it is possible to start from each of the object pixel points in the detection frame of the object to perform depth diffusion on each of the pixel points in the detection frame of the object based on the color change situation of each of the pixel points in the detection frame of the object, so as to determine an actual depth of each pixel point in the detection frame of the object.

Then, for the detection frame of each object, the present application can determine spatial position information in the three-dimensional scene corresponding to each of the pixel points in the detection frame of the object by analyzing the pixel coordinates and actual depth of each pixel point in the detection frame. Then, it is possible to determine spatial boundary information of the object in the three-dimensional scene by analyzing the spatial position information in the three-dimensional scene corresponding to each pixel point in the detection frame of the object, so as to generate the minimum bounding box of the object.

In the same way as above, it is possible to generate the minimum bounding box of each object in the three-dimensional scene, and in three-dimensional scene reconstruction, it is possible to approximately replace each of the complex objects with the minimum bounding box with a simple geometric structure, so as to implement efficient and accurate reconstruction of each of the objects in the three-dimensional scene.

According to the technical solution provided by the embodiments of the present application, firstly, a color image and a depth image of a three-dimensional scene at the same time after calibration and alignment are acquired, and prior depths of object pixel points obtained after depth clustering in a detection frame of each object in the color image are determined based on matching of pixel points between the color image and the depth image. Then, depth diffusion is performed on each of the pixel points in the detection frame of the object based on color information of each pixel point in the detection frame of each object and the prior depths of the object pixel points to generate a minimum bounding box of the object. That is, it is possible to approximately replace each of the complex objects with the minimum bounding box with a simple geometric structure, which can implement efficient and accurate reconstruction of each of the objects in the three-dimensional scene, and perform depth diffusion on each of the pixel points in the detection frame of each object, without analyzing the depth information of each pixel point in the whole color image, which can greatly reduce the computational overhead in reconstruction of each of the objects in the three-dimensional scene and can improve the reconstruction reliability of each of the objects in the three-dimensional scene.

As an optional implementation in the present application, in order to ensure the efficient and accurate reconstruction of each object in the three-dimensional scene, the present application can explain in detail the clustering process and the depth diffusion process of each of the pixel points in the detection frame of each object in the color image.

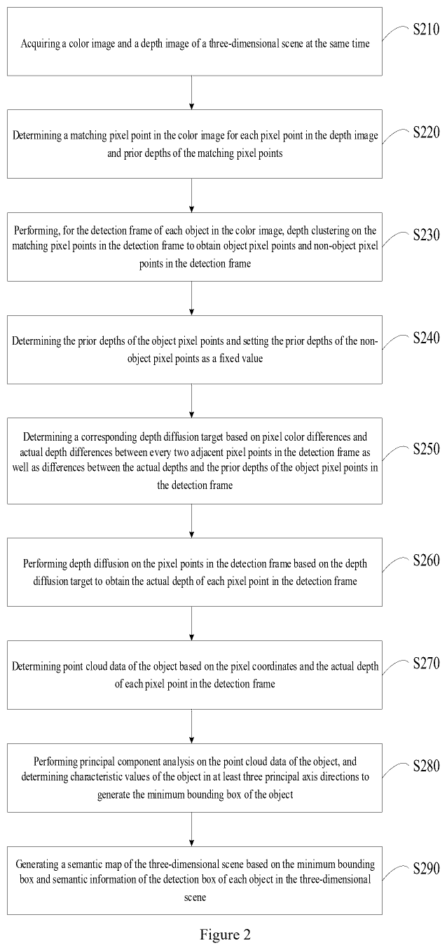

FIG. 2 is a flow diagram of another three-dimensional scene reconstruction method provided by an embodiment of the present application. As shown in FIG. 2, the method can specifically include the following steps:
S210, acquiring a color image and a depth image of a three-dimensional scene at the same time;
S220, determining a matching pixel point in the color image for each pixel point in the depth image and prior depths of the matching pixel points.

After acquiring a color image and a depth image of a three-dimensional scene at the same time, in order to accurately acquire point cloud data of any object, the present application can first acquire the coordinate transformation relationship of the ordinary camera and the depth camera after calibration and alignment. Since the pixel resolution of the color image will be usually higher than that of the depth image, the number of pixel points in the color image can be larger than that in the depth image. Then, each pixel point in the depth image can have a matching pixel point in the color image.

Therefore, the present application can use the coordinate transformation relationship between the ordinary camera and the depth camera after calibration and alignment to perform coordinate transformation on the pixel coordinates of each pixel point in the depth image so as to obtain the transformed pixel coordinates of each pixel point. Then, in the color image, it is possible to find out a certain pixel point, whose pixel coordinates are the same as the transformed pixel coordinates of each pixel point in the depth image, as a matching pixel point of the pixel point in the depth image. Therefore, in the color image, it is possible to determine the matching pixel point for each pixel point in the depth image. Then, the depth information of each pixel point in the depth image is taken as the prior depths of the matching pixel points of the pixel points in the color image.

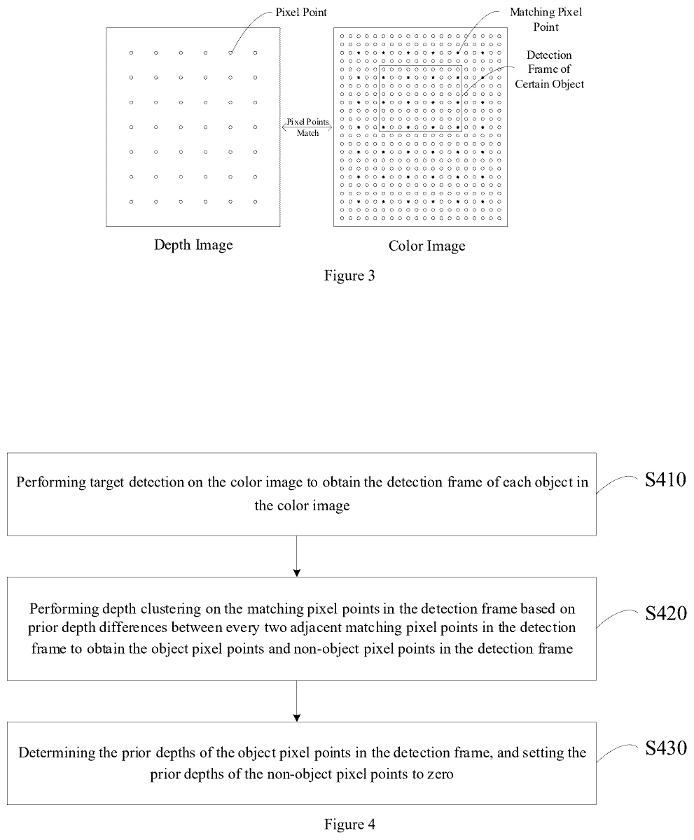

Illustratively, the pixel resolution of the depth image is smaller than that of the color image. Then, as shown in FIG. 3, for each pixel point in the depth image, it is possible to determine the matching pixel point of the pixel point in the color image, and take the depth information of each pixel point in the depth image as the prior depth of the matching pixel point of the pixel point. The pixel points represented by “★” in the color image in FIG. 3 are the matching pixel points for each of the pixel points in the depth image.

S230, for the detection frame of each object in the color image, performing depth clustering on the matching pixel points in the detection frame to obtain object pixel points and non-object pixel points in the detection frame.

In order to reduce the computational overhead in reconstruction of each object in the three-dimensional scene, for the color image, the present application can use the corresponding target detection algorithm to perform target detection processing on each object in the color image so as to obtain the detection frame of each object in the color image.

Since the pixel points in the color image can be divided into two types, i.e., matching pixel points and unmatching ordinary pixel points of each of the pixel points in the depth image, as shown in FIG. 3, it is possible to determine each of the pixel points in the detection frame of each object based on a boundary position where the detection frame of each object is located in the color image, and each of the pixel points in the detection frame also includes the two types, i.e., matching pixel points and unmatching ordinary pixel points of the corresponding pixel points in the depth image.

Then, considering that a portion of background outside the object will be framed in the detection frame of each object in addition to the object, the pixel points in the detection frame of each object can be divided into two types, i.e., object pixel points inside the object and non-object pixel points outside the object, which means that the matching pixel points in the detection frame of each object can also be divided into object pixel points inside the object and non-object pixel points outside the object.

Then, for the detection frame of each object in the color image, the present application can perform depth clustering processing on each of the matching pixel points in the detection frame based on the depth information of each of the matching pixel points in the detection frame of the object, so as to divide each of the matching pixel points in the detection frame of the object into two types, i.e., object pixel points and non-object pixel points. Therefore, in order to ensure the high efficiency of reconstruction of objects, the present application can directly determine the object pixel points and non-object pixel points into which the matching pixel points in the detection frame of each object are divided.

In some implementations, for the object pixel points in the detection frame of each object, as shown in FIG. 4, the present application can be determined by the following step:
S410, performing target detection on the color image to obtain the detection frame of each object in the color image.

For the target detection of the color image, the present application can pre-train a target detection model, which is trained by using a corresponding target detection algorithm to accurately detect each object in the color image.

For each acquired color image, the present application will input the color image into the pre-trained target detection model to detect and identify each of the objects in the color image through the target detection model, so as to output the detection frame of each object in the color image.

It can be understood that when target detection is performed on each of the objects in the color image, specific information of each of the objects will be identified to output semantic information of the detection frame of each object, so as to express a specific identification meaning of the framed objects.

S420, performing depth clustering on the matching pixel points in the detection frame based on prior depth differences between every two adjacent matching pixel points in the detection frame to obtain the object pixel points in the detection frame.

It is considered that the depth difference of each of the pixel points of the inside of the same object in the color image is small, while the depth difference (facing users) of pixel points corresponding to a certain object and other object or background in the color image is large. Moreover, for each of the matching pixel points in the detection frame of each object in the color image, the matching pixel points include both of object pixel points inside the object and non-object pixel points outside the object.

Therefore, in order to ensure the efficient reconstruction of each of the objects in the three-dimensional scene, for the detection frame of each object in the color image, the present application can first find out one matching pixel point that must be inside the object from each of the matching pixel points in the detection frame of the object, and then, starting from the matching pixel point, analyze whether the prior depth difference between the matching pixel point and its adjacent matching pixel point is larger than a preset depth difference threshold. If the prior depth difference between the matching pixel point and its adjacent matching pixel point is less than or equal to the preset depth difference threshold, it means that the matching pixel point and its adjacent matching pixel point belong to pixel points inside the same object, and then the matching pixel point and its adjacent matching pixel point are clustered into one class as the object pixel points inside the object. In contrast, if the prior depth difference between the matching pixel point and its adjacent matching pixel point is larger than the preset depth difference threshold, it means that the adjacent matching pixel point of the matching pixel point is different from the matching pixel point in that it does not belong to the pixel points inside the object. Then it is possible to cluster the adjacent matching pixel point of the matching pixel point into one class as the non-object pixel point outside the object.

Then, each of the adjacent matching pixel points of the matching pixel points are taken as new start pixel points to analyze again whether the prior depth difference between the new start pixel point and its adjacent matching pixel point is larger than the preset depth difference threshold. The loop is repeated to continuously analyze the prior depth differences between every two adjacent matching pixel points, so as to cluster each of the adjacent matching pixel points into one class of object pixel points and non-object pixel points until all the matching pixel points in the detection frame of the object are traversed, and the object pixel points in the detection frame of the object can be obtained.

Illustratively, the present application can use the breadth-first search algorithm to perform depth clustering on each of the matching pixel points in the detection frame of each object. The specific process is as follows: for the detection frame of each object, the central pixel point in the detection frame can be determined as the pixel point inside the object. Then, the present application can start from the central matching pixel point in the detection frame of the object to traverse each of neighborhoods of the central matching pixel point, so as to determine each of the adjacent matching pixel points of the central matching pixel point. If the prior depth difference between the central matching pixel point and a certain adjacent matching pixel point is less than or equal to a preset depth difference threshold (for example, 0.1 m), the two adjacent matching pixel points are deemed to belong to the same class, that is, the pixel points belonging to the inside of the object, which are clustered as corresponding object pixel points. In contrast, if the prior depth difference between the central matching pixel point and a certain adjacent matching pixel point is greater than a preset depth difference threshold (for example, 0.1 m), the two adjacent matching pixel points are deemed to belong to different classes, and the adjacent matching pixel point is classified into non-object pixel points outside the object.

Then, each of the adjacent matching pixel points is taken as a new start pixel point, starting from which, each of the neighborhoods of the new start pixel point are traversed again to determine each of the adjacent matching pixel points of the new start pixel point and the same pixel point clustering step as mentioned above is performed. The loop is repeated until all matching pixel points in the detection frame of the object are traversed. Finally, each of the object pixel points in the detection frame of the object can be obtained based on the clustering results of each of the matching pixel points in the detection frame of each object.

It should be noted that, for the object pixel points and non-object pixel points in the detection frame of each object, the present application can also use other clustering algorithm than the depth clustering algorithm for division based on other pixel difference of the object pixel points and non-object pixel points. The present application makes no limitation on the specific clustering mode adopted for division of the object pixel points and non-object pixel points in the detection frame of each object.

S240, determining the prior depths of the object pixel points and setting the prior depths of the non- object pixel points as a fixed value.

For the detection frame of each object, it is possible to directly acquire the prior depths of each of the object pixel points in the detection frame of the object. Considering that there is no need in object reconstruction to refer to the depths of non-object pixel points so as to reduce the computational overhead in object reconstruction, the present application can set the prior depths of each of the non-object pixel points in the detection frame of each object to a certain fixed value, wherein the fixed value can be zero.

S250, determining a corresponding depth diffusion target based on pixel color differences and actual depth differences between every two adjacent pixel points in the detection frame as well as differences between the actual depths and the prior depths of the object pixel points in the detection frame.

Considering that the depth difference of two pixel points belonging to the same object in the color image is not large, and if the color difference of the two pixel points in the detection frame of the object is not large, it means that the two pixel points belong to pixel points on the same object, then the depth difference of these two pixel points is not large, either. Moreover, any two adjacent pixel points in the detection frame of a certain object in the color image may generally represent the same object approximately, so that the depth difference between any two adjacent pixel points is as small as possible.

From the above, it can be learned that, when depth diffusion is performed on each of the pixel points in the detection frame of each object, every two adjacent pixel points in the detection frame of the object should satisfy that the actual depth difference between the two adjacent pixel points should be as small as possible and consistent with the change situation of the pixel color difference between the two adjacent pixel points.

Moreover, since a portion of object pixel points in the detection frame of each object already has the corresponding prior depths, in order to ensure the accuracy of object reconstruction, for each of the object pixel points in the detection frame of each object, the object pixel points should satisfy a condition that the difference between its actual depth and prior depth should be as small as possible.

Therefore, according to the above two conditions that each pixel point in the detection frame of each object should satisfy, the present application can make a corresponding limitation on the actual depth difference between the every two adjacent pixel points based on the pixel color difference between the two adjacent pixel points in the detection frame of the object, and make a corresponding limitation on the actual depth of each object pixel point based on the prior depth of the object pixel point in the detection frame of the object, so as to construct the depth diffusion target corresponding to each of the pixel points in the detection frame of each object.

In some implementations, for the depth diffusion target corresponding to each of the pixel points in the detection frame of each object, the present application can determine in the following way: determine a corresponding depth diffusion smoothing term based on the pixel color difference and actual depth difference between each pixel point in the detection frame and the adjacent pixel point of the pixel point; determine a corresponding depth diffusion regularization term based on the difference between the actual depth and the prior depth of the object pixel point in the detection frame; determine a corresponding depth diffusion target based on the depth diffusion smoothing term and the depth diffusion regularization term.

In other words, for each pixel point in the detection frame of each object, since the pixel point and its adjacent pixel point may be usually represented as the same object approximately, the actual depth difference between the two adjacent pixel points is as small as possible. Moreover, the pixel color difference between the two adjacent pixel points will also result in a corresponding positive impact on the actual depth difference between the two adjacent pixel points. Thus it can be learned that, if the pixel color difference between the pixel point and its adjacent pixel point is smaller, which means that the actual depth difference between the two adjacent pixel points will also be smaller, the actual depth difference between the two adjacent pixel points has a greater weight in depth diffusion.

Therefore, for each pixel point in the detection frame of each object, the present application can set the weight of the actual depth difference between the two adjacent pixel points in depth diffusion based on the pixel color difference between the pixel point and its adjacent pixel point, so as to obtain the depth diffusion smoothing term corresponding to the pixel point.

Illustratively, the depth diffusion smoothing term can be:

$${E}_{1} = \{ {{Q}_{i j 1} ( {x}_{i j} - {x}_{i + 1 j} )}^{2} + {{Q}_{i j 2} ( {x}_{i , j} - {x}_{i - 1 , j} )}^{2} + {{Q}_{i j 3} ( {x}_{i , j} - {x}_{i , j + 1} )}^{2} + {{Q}_{i j 4} ( {x}_{i , j} - {x}_{i , j - 1} )}^{2} \}$$

where, the actual depth of each pixel point in the detection frame of each object can be x_{i,j}, then x_{i+1,j}, x_{i-1,j}, x_{i,j+1} and x_{i,j-1} are respectively the actual depths of the adjacent pixel points of the pixel, and Qᵢⱼ₁, Qᵢⱼ₂, Qᵢⱼ₃, and Qᵢⱼ₄ are respectively the reciprocals of the pixel color differences between the pixel point and the adjacent pixel points. It means that the smaller the pixel color difference between two certain adjacent pixel points is, the greater the weight of the actual depth difference between the two adjacent pixel points in depth diffusion, so that the actual depth difference between the two adjacent pixel points can be as much as possible.

Moreover, since a portion of object pixel points in the detection frame of each object already has the corresponding prior depths and the object pixel point should satisfy the condition that the difference between its actual depth and prior depth should be as small as possible, for each object pixel point in the detection frame of each object, the present application can set the difference between the actual depth and the prior depth of the object pixel point to obtain the depth diffusion regularization term corresponding to the pixel point.

Illustratively, the depth diffusion regularization term can be: E₂=Wᵢⱼ(x_{i,j}−y_{i,j})²,
where, the actual depth of each pixel point in the detection frame of each object can be x_{i,j}, then y_{i,j} can be the prior depth of the pixel point.

$${W}_{i , j} = \{ \begin{matrix}1 & {y}_{i , j} is valid \\ 0 & {y}_{i , j} is invalid\end{matrix} ,$$

Moreover, which means that the corresponding depth diffusion regularization term is used only when the prior depth y_{i,j} of the pixel point is valid (there is a depth value). In contrast, when the prior depth y_{i,j} of the pixel point is invalid (there is no depth value), it is possible to directly set the depth diffusion regularization term to 0 without participating in depth diffusion.

Then, after determining the corresponding depth diffusion smoothing term and depth diffusion regularization term, the present application can directly set the sum of the depth diffusion smoothing term and depth diffusion regularization term to a minimum, so as to determine the corresponding depth diffusion target.

Illustratively, the depth diffusion target can be:

$$E = arg min {\sum }_{i = 0}^{N} {\sum }_{j = 0}^{M} ( {E}_{1} + {E}_{2} ) ,$$

where, N and M respectively represent the pixel length and width information of the detection frame of each object.

S260, performing depth diffusion on the pixel points in the detection frame based on the depth diffusion target to obtain the actual depth of each pixel point in the detection frame.

The goal of depth diffusion of the present application is to solve the Laplace's optimization problem, wherein the optimization variable is the actual depth x_{i,j} of each pixel point in the detection frame of each object.

Therefore, the actual depth of each pixel point in the detection frame of the object can be computed by solving the above-mentioned depth diffusion target using Laplace's optimization problem.

S270, determining point cloud data of the object based on the pixel coordinates and the actual depth of each pixel point in the detection frame.

For each pixel point in the detection frame of each object in the color image, the present application can uniformly process the pixel coordinates and the actual depth of the pixel point to transform the pixel point to a certain spatial point in a three-dimensional scene. Hereby, the point cloud data of the object can be determined based on the transformation of each of the pixel points in the detection frame of each object to each of the spatial points in the three-dimensional scene.

S280, performing principal component analysis on the point cloud data of the object, and determining characteristic values of the object in at least three principal axis directions to generate the minimum bounding box of the object.

For each object in a three-dimensional scene, it is possible to use a space bounding box with a different shape to approximately replace the object. For example, the space bounding box can include a cube, a polyhedron composed of more than four polygons, and the like. However, a space coordinate system suitable for a different space bounding box will have a different principal axis direction. For example, the space coordinate system corresponding to a cube can include three principal axis directions: X axis, Y axis and Z axis. Moreover, in the principal component analysis algorithm, each principal component can be used to represent each of the corresponding principal axis directions when the object is bounded.

Therefore, the present application can perform corresponding principal component analysis on the point cloud data of each object based on the characteristics of the object bounding box as used to transform the point cloud data of the object into at least three characteristic vectors, and determine a characteristic value of the object on each characteristic vector. The at least three characteristic vectors can represent at least three principal axis directions corresponding to the bounding box, and the characteristic value of the object on each characteristic vector can represent a length of the bounding box corresponding to the object in each principal axis direction.

Then, the minimum bounding box of the object can be generated based on the length of the bounding box corresponding to each object in each of the principal axis directions, whereby to approximately replace each of the complex objects with the minimum bounding box with a simple geometric structure, thus implementing efficient and accurate reconstruction of each of the objects in the three-dimensional scene.

S290, generating a semantic map of the three-dimensional scene based on the minimum bounding box and semantic information of the detection frame of each object in the three-dimensional scene.

In the three-dimensional scene, it is possible to generate the minimum bounding box of each object whereby to approximately replace each of the complex objects with the minimum bounding box with a simple geometric structure, thus implementing efficient reconstruction of each of the objects in the three-dimensional scene. Then, the specific object information represented by each minimum bounding box in the three-dimensional scene is determined based on the semantic information of the detection box of each object, so that the corresponding object information is marked on each of the minimum bounding boxes generated in the three-dimensional scene to generate a semantic map of the three-dimensional scene.

According to the technical solutions provided by the embodiments of the present application, firstly, a color image and a depth image of a three-dimensional scene at the same time after calibration and alignment are acquired, and prior depths of object pixel points obtained after depth clustering in a detection frame of each object in the color image is determined based on matching of pixel points between the color image and the depth image. Then, depth diffusion is performed on the pixel points in the detection frame of each object based on color information of each of the pixel points in the detection frame of the object and the prior depths of the object pixel points to generate a minimum bounding box of the object. That is, it is possible to approximately replace each of the complex objects with the minimum bounding box with a simple geometric structure, which can implement efficient and accurate reconstruction of each of the objects in the three-dimensional scene. In addition, performing depth diffusion on the pixel points in the detection frame of each object without analyzing the depth information of each pixel point in the whole color image greatly reduces the computational overhead in reconstruction of each of the objects in the three-dimensional scene and can improve the reconstruction reliability of each of the objects in the three-dimensional scene.

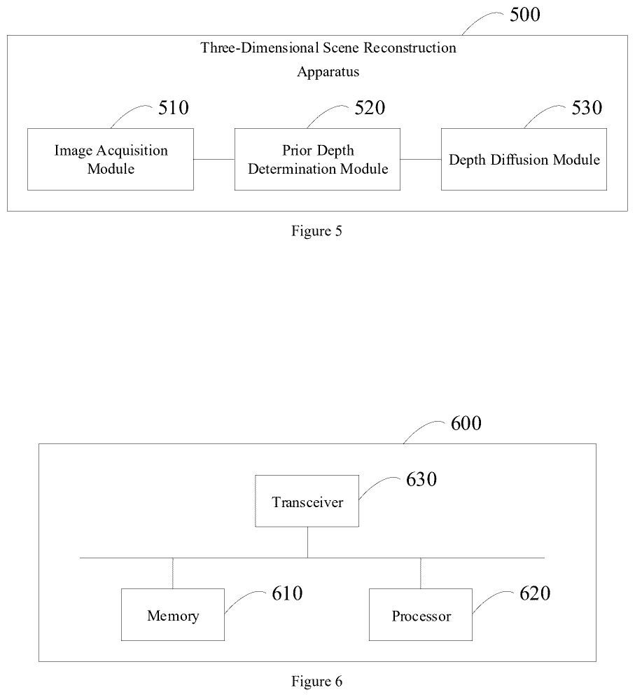

FIG. 5 is a principle block diagram of a three-dimensional scene reconstruction apparatus provided by an embodiment of the present application. As shown in FIG. 5, the three-dimensional scene reconstruction apparatus 500 can include:
an image acquisition module 510 for acquiring a color image and a depth image of a three-dimensional scene at the same time;
a prior depth determination module 520 for determining, based on the depth image, prior depths of object pixel points obtained after depth clustering in a detection frame of each object in the color image;
a depth diffusion module 530 for performing depth diffusion on the pixel points in the detection frame based on color information of each pixel point in the detection frame and the prior depths of the object pixel points to obtain an actual depth of each pixel point in the detection frame, so as to generate a minimum bounding box of the object.

In some implementations, the prior depth determination module 520 can include:
a pixel point matching unit for determining a matching pixel point in the color image for each pixel point in the depth image and the prior depths of the matching pixel points;
a pixel point clustering unit for performing, for a detection frame of each object in the color image, depth clustering on the matching pixel points in the detection frame to obtain object pixel points and non-object pixel points in the detection frame;
a prior depth determining unit for determining the prior depths of the object pixel points and setting the prior depths of the non-object pixel points to a fixed value.

In some implementations, the pixel point clustering unit can be specifically configured for:
performing target detection on the color image to obtain a detection frame of each object in the color image;
performing depth clustering on the matching pixel points in the detection frame based on prior depth differences between every two adjacent matching pixel points in the detection frame to obtain object pixel points in the detection frame.

In some implementations, the depth diffusion module 530 can include:
a depth diffusion target determining unit for determining a corresponding depth diffusion target based on pixel color differences and actual depth differences between every two adjacent pixel points in the detection frame as well as differences between the actual depths and the prior depths of the object pixel points in the detection frame;
a depth diffusion unit for performing depth diffusion on the pixel points in the detection frame based on the depth diffusion target to obtain the actual depth of each pixel point in the detection frame.

In some implementations, the depth diffusion target determining unit can be specifically configured for:
determining a depth diffusion smoothing term based on the pixel color differences and the actual depth differences between each pixel point and adjacent pixel points of the pixel point in the corresponding detection frame;
determining a depth diffusion regularization term based on the differences between the actual depths and the prior depths of the object pixel points in the corresponding detection frame;
determining a depth diffusion target based on the corresponding depth diffusion smoothing term and the depth diffusion regularization term.

In some implementations, the depth diffusion module 530 can further include a bounding box generating unit. The bounding box generating unit can be configured for:
determining point cloud data of the object based on the pixel coordinates and the actual depth of each pixel point in the detection frame;
performing principal component analysis on the point cloud data of the object, and determining characteristic values of the object in at least three principal axis directions to generate the minimum bounding box of the object.

In some implementations, the three-dimensional scene reconstruction apparatus 500 can further include:
a semantic map generation module for generating a semantic map of the three-dimensional scene based on the minimum bounding box and the detection box semantic information of each object in the three-dimensional scene.

In the embodiment of the present application, firstly, a color image and a depth image of a three-dimensional scene at the same time after calibration and alignment are acquired, and prior depths of object pixel points obtained after depth clustering in a detection frame of each object in the color image are determined based on matching of pixel points between the color image and the depth image. Then, depth diffusion is performed on each of the pixel points in the detection frame of the object based on color information of each pixel point in the detection frame of each object and the prior depths of the object pixel points to generate a minimum bounding box of the object. That is, it is possible to approximately replace each of the complex objects with the minimum bounding box with a simple geometric structure, which can implement efficient and accurate reconstruction of each of the objects in the three-dimensional scene, and perform depth diffusion on each of the pixel points in the detection frame of each object without analyzing the depth information of each pixel point in the whole color image, which can greatly reduce the computational overhead in reconstruction of the objects in the three-dimensional scene and can improve the reconstruction reliability of the objects in the three-dimensional scene.

It should be understood that the apparatus embodiment and the method embodiment in the present application can correspond to each other, and similar descriptions can refer to the method embodiment in the present application. In order to avoid repetition, no further detail will be described.

Specifically, the apparatus 500 shown in FIG. 5 can execute any method embodiment provided by the present application, and the aforementioned and other operations and/or functions of each of the modules in the apparatus 500 shown in FIG. 5 are respectively to implement the corresponding flow of the above method embodiment, and are not repeated here for brevity.

The above-mentioned method embodiment of the embodiments of the present application is described above from the perspective of functional modules and in combination with the drawings. It should be understood that the functional modules can be implemented in the form of hardware, or by instructions in the form of software, or by a combination of hardware and software modules. Specifically, each of the steps of the method embodiment in the embodiments of the present application can be completed by integrated logic circuitry of hardware and/or instructions in the form of software in the processor, and the steps of the method disclosed in combination with the embodiment of the present application can be directly embodied as being executed by a hardware decoding processor or by a combination of hardware and software modules in the decoding processor. Optionally, the software module can be located in a mature storage medium in the art such as a Random Access Memory, flash memory, Read-Only Memory, Programmable Read-Only Memory, Electrically Erasable Programmable Memory, register, or the like. The storage medium is located in the memory, and the processor reads information in the memory and completes the steps in the above method embodiment in combination with its hardware.

FIG. 6 is a schematic block diagram of an electronic device provided by an embodiment of the present application.

As shown in FIG. 6, the electronic device 600 can include:
a memory 610 and a processor 620, wherein the memory 610 is configured for storing a computer program and transmitting program codes to the processor 620. In other words, the processor 620 can call from the memory 610 and operate the computer program to implement the method in the embodiment of the present application.

For example, the processor 620 can be configured for executing the above method embodiment based on instructions in the computer program.

In some embodiments of the present application, the processor 620 can include, but is not limited to:
general-purpose processors, Digital Signal Processors (DSPs), Application Specific Integrated Circuits (ASICs), Field Programmable Gate Arrays (FPGAs) or other programmable logic devices, discrete gate or transistor logic devices, discrete hardware components, and so on.

In some embodiments of the present application, the memory 610 includes, but is not limited to:
volatile memories and/or nonvolatile memories. The nonvolatile memories can be Read-Only Memories (ROMs), Programmable Read-Only Memories (PROMs), Erasable Programmable Read-Only Memories (EPROMs), Electrically Erasable Programmable Read-Only Memories (EEPROMs) or flash memories. The volatile memories can be Random Access Memories (RAMs), which are used as external caches. By way of illustrative but not limiting explanations, RAMs in many forms are available, such as Static Random Access Memories (SRAMs), Dynamic Random Access Memories (DRAMs), Synchronous Dynamic Random Access Memories (Synchronous DRAMs, SDRAMs), Double Data Rate Synchronous Dynamic Random Access Memories (Double Data Rate SDRAM, DDR SDRAMs), Enhanced Synchronous Dynamic Random Access Memories (Enhanced SDRAMs, ESDRAMs), synchronous link Dynamic Random Access Memories (synch link DRAMs, SLDRAMs) and Direct Memory Bus Random Access Memories (Direct Rambus RAMs, DR RAMs).

In some embodiments of the present application, the computer program can be divided into one or more modules, which are stored in the memory 610 and executed by the processor 620 to complete the method provided by the present application. The one or more modules can be a series of instruction segments of the computer program that can complete specific functions, and the instruction segments are used to describe the execution process of the computer program in the electronic device 600.

As shown in FIG. 6, the electronic device can further include:
a transceiver 630, which can be connected to the processor 620 or the memory 610.

The processor 620 can control the transceiver 630 to communicate with other devices, specifically, it can send information or data to other devices or receive information or data sent by other devices. The transceiver 630 can include a transmitter and a receiver. The transceiver 630 can further include antenna(s), and the number of antenna(s) can be one or more.

It should be understood that the components in the electronic device 600 are connected by a bus system, wherein the bus system includes a power bus, a control bus and a status signal bus in addition to a data bus.

The present application further provides a computer storage medium, on which a computer program is stored and, when executed by a computer, enables the computer to execute the method of the above method embodiment.

An embodiment of the present application further provides a computer program product containing a computer program/instructions, which, when executed by a computer, cause the computer to execute the method of the above method embodiment.

When implemented in software, it can be fully or partially implemented in the form of a computer program product. The computer program product includes one or more computer instructions. When the computer program instructions are loaded and executed on a computer, the flow or functions according to the embodiment of the present application are generated fully or partially. The computer can be a general-purpose computer, a special-purpose computer, a computer network, or other programmable devices. The computer instructions can be stored in a computer-readable storage medium or transmitted from one computer-readable storage medium to another. For example, the computer instructions can be transmitted from one website, computer, server, or data center to another website, computer, server, or data center in a wired (such as coaxial cable, optical fiber, digital subscriber line (DSL)) or wireless (such as infrared, wireless, microwave, etc.) way. The computer-readable storage medium can be any available medium that a computer can access or a server, a data center, or other data storage device that is integrated with one or more available media. The available media can be magnetic media (e.g., floppy disk, hard disk, magnetic tape), optical media (e.g., digital video disc (DVD)), or semiconductor media (e.g., solid state disk (SSD)) and the like.

The above are only the specific implementations of the present application, but the protection scope of the present application is not limited to this. Any skilled person familiar with this technical field can easily think of changes or substitutions within the technical scope disclosed in the present application, which should be included in the protection scope of the present application. Therefore, the protection scope of the present application should be based on the protection scope of the claims.

What is claimed is:

1. A three-dimensional scene reconstruction method, comprising:
acquiring a color image and a depth image of a three-dimensional scene at the same time;
determining, based on the depth image, prior depths of object pixel points obtained after depth clustering in a detection frame of each object in the color image;
performing depth diffusion on the pixel points in the detection frame based on color information of each pixel point in the detection frame and the prior depths of the object pixel points to obtain an actual depth of each pixel point in the detection frame, so as to generate a minimum bounding box of the object.

2. The method according to claim 1, wherein the determining, based on the depth image, prior depths of object pixel points obtained after depth clustering in a detection frame of each object in the color image comprises:
determining a matching pixel point in the color image for each pixel point in the depth image and prior depths of the matching pixel points;
performing, for the detection frame of each object in the color image, the depth clustering on the matching pixel points in the detection frame to obtain object pixel points and non-object pixel points in the detection frame;
determining the prior depths of the object pixel points and setting the prior depths of the non-object pixel points as a fixed value.

3. The method according to claim 2, wherein the performing, for the detection frame of each object in the color image, the depth clustering on the matching pixel points in the detection frame to obtain object pixel points in the detection frame comprises:
performing target detection on the color image to obtain the detection frame of each object in the color image;
performing depth clustering on the matching pixel points in the detection frame based on prior depth differences between every two adjacent matching pixel points in the detection frame to obtain the object pixel points in the detection frame.

4. The method according to claim 1, wherein the performing, based on color information of each pixel point in the detection frame and the prior depths of the object pixel points, depth diffusion on the pixel points in the detection frame to obtain an actual depth of each pixel point in the detection frame comprises:
determining a corresponding depth diffusion target based on pixel color differences and actual depth differences between every two adjacent pixel points in the detection frame as well as differences between the actual depths and the prior depths of the object pixel points in the detection frame;
performing depth diffusion on the pixel points in the detection frame based on the depth diffusion target to obtain the actual depth of each pixel point in the detection frame.

5. The method according to claim 4, wherein the determining a corresponding depth diffusion target based on pixel color differences and actual depth differences between every two adjacent pixel points in the detection frame as well as differences between the actual depths and the prior depths of the object pixel points in the detection frame, comprises:
determining a corresponding depth diffusion smoothing term based on the pixel color differences and the actual depth differences between each pixel point and adjacent pixel points of the pixel point in the detection frame;
determining a corresponding depth diffusion regularization term based on the differences between the actual depths and the prior depths of the object pixel points in the detection frame;
determining a corresponding depth diffusion target based on the depth diffusion smoothing term and the depth diffusion regularization term.

6. The method according to claim 1, wherein the generating a minimum bounding box of the object comprises:
determining point cloud data of the object based on pixel coordinates and the actual depth of each pixel point in the detection frame;
performing principal component analysis on the point cloud data of the object, and determining characteristic values of the object in at least three principal axis directions to generate the minimum bounding box of the object.

7. The method according to claim 1, wherein the method further comprises:
generating a semantic map of the three-dimensional scene based on the minimum bounding box and semantic information of the detection frame of each object in the three-dimensional scene.

8. An electronic device, comprising:
a processor; and
a memory for storing executable instructions of the processor;
wherein, the processor is configured to execute a three-dimensional scene reconstruction method by executing the executable instructions, the three-dimensional scene reconstruction method comprising:
acquiring a color image and a depth image of a three-dimensional scene at the same time;
determining, based on the depth image, prior depths of object pixel points obtained after depth clustering in a detection frame of each object in the color image;
performing depth diffusion on the pixel points in the detection frame based on color information of each pixel point in the detection frame and the prior depths of the object pixel points to obtain an actual depth of each pixel point in the detection frame, so as to generate a minimum bounding box of the object.

9. The electronic device according to claim 8, wherein the determining, based on the depth image, prior depths of object pixel points obtained after depth clustering in a detection frame of each object in the color image comprises:
determining a matching pixel point in the color image for each pixel point in the depth image and prior depths of the matching pixel points;
performing, for the detection frame of each object in the color image, the depth clustering on the matching pixel points in the detection frame to obtain object pixel points and non-object pixel points in the detection frame;
determining the prior depths of the object pixel points and setting the prior depths of the non-object pixel points as a fixed value.

10. The electronic device according to claim 9, wherein the performing, for the detection frame of each object in the color image, the depth clustering on the matching pixel points in the detection frame to obtain object pixel points in the detection frame comprises:
performing target detection on the color image to obtain the detection frame of each object in the color image;
performing depth clustering on the matching pixel points in the detection frame based on prior depth differences between every two adjacent matching pixel points in the detection frame to obtain the object pixel points in the detection frame.

11. The electronic device according to claim 8, wherein the performing, based on color information of each pixel point in the detection frame and the prior depths of the object pixel points, depth diffusion on the pixel points in the detection frame to obtain an actual depth of each pixel point in the detection frame comprises:
determining a corresponding depth diffusion target based on pixel color differences and actual depth differences between every two adjacent pixel points in the detection frame as well as differences between the actual depths and the prior depths of the object pixel points in the detection frame;
performing depth diffusion on the pixel points in the detection frame based on the depth diffusion target to obtain the actual depth of each pixel point in the detection frame.

12. The electronic device according to claim 11, wherein the determining a corresponding depth diffusion target based on pixel color differences and actual depth differences between every two adjacent pixel points in the detection frame as well as differences between the actual depths and the prior depths of the object pixel points in the detection frame, comprises:
determining a corresponding depth diffusion smoothing term based on the pixel color differences and the actual depth differences between each pixel point and adjacent pixel points of the pixel point in the detection frame;
determining a corresponding depth diffusion regularization term based on the differences between the actual depths and the prior depths of the object pixel points in the detection frame;
determining a corresponding depth diffusion target based on the depth diffusion smoothing term and the depth diffusion regularization term.

13. The electronic device according to claim 8, wherein the generating a minimum bounding box of the object comprises:
determining point cloud data of the object based on pixel coordinates and the actual depth of each pixel point in the detection frame;
performing principal component analysis on the point cloud data of the object, and determining characteristic values of the object in at least three principal axis directions to generate the minimum bounding box of the object.

14. The electronic device according to claim 8, wherein the method further comprises:
generating a semantic map of the three-dimensional scene based on the minimum bounding box and semantic information of the detection frame of each object in the three-dimensional scene.

15. A non-transitory computer-readable storage medium on which a computer program is stored, wherein the computer program, when executed by a processor, implements a three-dimensional scene reconstruction method, comprising:
acquiring a color image and a depth image of a three-dimensional scene at the same time;
determining, based on the depth image, prior depths of object pixel points obtained after depth clustering in a detection frame of each object in the color image;
performing depth diffusion on the pixel points in the detection frame based on color information of each pixel point in the detection frame and the prior depths of the object pixel points to obtain an actual depth of each pixel point in the detection frame, so as to generate a minimum bounding box of the object.

16. The non-transitory computer-readable storage medium according to claim 15, wherein the determining, based on the depth image, prior depths of object pixel points obtained after depth clustering in a detection frame of each object in the color image comprises:
determining a matching pixel point in the color image for each pixel point in the depth image and prior depths of the matching pixel points;
performing, for the detection frame of each object in the color image, the depth clustering on the matching pixel points in the detection frame to obtain object pixel points and non-object pixel points in the detection frame;
determining the prior depths of the object pixel points and setting the prior depths of the non-object pixel points as a fixed value.

17. The non-transitory computer-readable storage medium according to claim 16, wherein the performing, for the detection frame of each object in the color image, the depth clustering on the matching pixel points in the detection frame to obtain object pixel points in the detection frame comprises:
performing target detection on the color image to obtain the detection frame of each object in the color image;
performing depth clustering on the matching pixel points in the detection frame based on prior depth differences between every two adjacent matching pixel points in the detection frame to obtain the object pixel points in the detection frame.

18. The non-transitory computer-readable storage medium according to claim 15, wherein the performing, based on color information of each pixel point in the detection frame and the prior depths of the object pixel points, depth diffusion on the pixel points in the detection frame to obtain an actual depth of each pixel point in the detection frame comprises:
determining a corresponding depth diffusion target based on pixel color differences and actual depth differences between every two adjacent pixel points in the detection frame as well as differences between the actual depths and the prior depths of the object pixel points in the detection frame;
performing depth diffusion on the pixel points in the detection frame based on the depth diffusion target to obtain the actual depth of each pixel point in the detection frame.

19. The non-transitory computer-readable storage medium according to claim 18, wherein the determining a corresponding depth diffusion target based on pixel color differences and actual depth differences between every two adjacent pixel points in the detection frame as well as differences between the actual depths and the prior depths of the object pixel points in the detection frame, comprises:
determining a corresponding depth diffusion smoothing term based on the pixel color differences and the actual depth differences between each pixel point and adjacent pixel points of the pixel point in the detection frame;
determining a corresponding depth diffusion regularization term based on the differences between the actual depths and the prior depths of the object pixel points in the detection frame;
determining a corresponding depth diffusion target based on the depth diffusion smoothing term and the depth diffusion regularization term.

20. The non-transitory computer-readable storage medium according to claim 15, wherein the generating a minimum bounding box of the object comprises:
determining point cloud data of the object based on pixel coordinates and the actual depth of each pixel point in the detection frame;
performing principal component analysis on the point cloud data of the object, and determining characteristic values of the object in at least three principal axis directions to generate the minimum bounding box of the object.
